(19) United States
(12) Patent Application Publication
(10) Pub. No.: US 2023/0159390 A1
(43) Pub. Date: May 25, 2023

(54) ABSORPTION OF SECONDARY ORGANIC AEROSOLS FROM CONSTRUCTION ELEMENTS

(71) Applicants: Elham Fini, Phoenix, AZ (US); Amirul Islam Rajib, Tempe, AZ (US); Shuguang Deng, Mesa, AZ (US)

(72) Inventors: Elham Fini, Phoenix, AZ (US); Amirul Islam Rajib, Tempe, AZ (US); Shuguang Deng, Mesa, AZ (US)

(21) Appl. No.: 17/993,355

(22) Filed: Nov. 23, 2022

Related U.S. Application Data
(60) Provisional application No. 63/282,501, filed on Nov. 23, 2021.
(60) Provisional application No. 63/406,224, filed on Sep. 13, 2022.

(51) Int. Cl. C04B 18/10; C04B 26/26; C04B 20/02; C04B 18/04; C01B 32/198; C01B 32/192

(52) U.S. Cl. CPC C04B 18/101; C04B 26/26; C04B 20/023; C04B 18/0481; C01B 32/198; C01B 32/192

(57) ABSTRACT

A composite including a polymeric material or emulsion and biochar. The composite includes 1 wt % to 20 wt % of the biochar. Making the composite includes combining biochar with a polymeric material or emulsion to yield a modified polymeric material or emulsion, and homogenizing the modified polymeric material or emulsion to yield the composite. Functionalizing biochar includes removing contaminants from the biochar to yield decontaminated biochar, oxidizing the decontaminated biochar to yield oxidized biochar, and functionalizing the oxidized biochar. Making nitrogen-doped biochar includes combining urea and wood residue to form a mixture, and heating the mixture in an oxygen-free environment to form the nitrogen-doped biochar.

### CROSS-REFERENCE TO RELATED APPLICATIONS

This application claims the benefit of U.S. Patent Application Nos. 63/282,501, filed on Nov. 23, 2021, and 63/406,224, filed on Sep. 13, 2022, both of which are incorporated herein by reference in their entirety.

### STATEMENT OF GOVERNMENT INTEREST

This invention was made with government support under 1928795 awarded by the National Science Foundation. The government has certain rights in the invention.

### TECHNICAL FIELD

This invention relates to biochar additives for composites including polymeric materials and emulsions for prevention of degradation and absorption of volatile and semi-volatile organic compounds and ozone precursors from non-combustion sources.

### BACKGROUND

Bituminous composites used in road and airport pavements, driveways, parking lots, and roofing shingles typically contain stone aggregate and bitumen, which works as a glue to bind the stones together. These composites become brittle with age and environmental exposure. Ultraviolet (UV) aging degrades bituminous composites and leads to premature cracking. Cracks allow water and debris into the underlying structures, further accelerating damage as a result of chemical oxidation and loss of volatiles in the bitumen upon exposure to heat, air, water, and UV radiation. Chemical oxidation is a consistent marker of aging, manifesting as an increase in carbonyl (C═O) and sulfoxide (S═O) groups, as well as some graphitization. These changes increase the strength of intermolecular bonding and aggregation in bitumen, leading to increased stiffness and reduced ductility. Oxidation typically proceeds through the formation of peroxides and related free-radical intermediates. Susceptibility to oxidative aging depends on both the chemical reactivity of bitumen (ether and ethylene groups are particularly prone to peroxidation, for example) and the diffusivity of oxygen and other reactive intermediates. Volatile loss of small molecules (roughly<300 Da) that might otherwise act as plasticizers in the matrix is also thought to depend strongly on bitumen composition and diffusivity. UV light can directly break chemical bonds and initiate reactions, yielding chemical products different from those of thermal aging and at a much faster rate. Thus, the durability of bituminous composites and associated construction materials is often limited by environmental factors.

### SUMMARY

Biochar additives for extending the service life of bituminous composites, as well as bituminous composites including biochar additives, are disclosed. As used herein, “biochar” generally refers to functionalized carbon derived from pyrolysis or thermochemical liquefaction of biomass (e.g., as a by-product of biodiesel production). In one example, algal biochar is derived from pyrolysis or thermochemical liquefaction of algae. The biochar works as a free-radical scavenger and solid sorbent that can be combined with (e.g., embedded in) various composites to delay ultraviolet aging and reduce air pollution from these composites. In particular, these composites are considered to be non-combustion sources that emit submicron atmospheric aerosols such as volatile and semi-volatile organic compounds and ozone precursors. Examples of composites that benefit from the addition of biochar include polymeric materials and emulsions, such as coatings, paints, and sealants. Other examples include pavement-related compositions, such as asphalt, bitumen (various grades), and fog seal, and construction elements such as buildings (including roofing) and furniture.

The biochar can be a by-product of biofuel production. In some cases, the biochar is derived from liquefaction, such as thermochemical liquefaction or hydrothermal liquefaction. In certain cases, the biochar is derived from pyrolysis. The biochar is typically 1 wt % to 20 wt % of the composite. The biochar can be biochar from algae, food waste, animal waste, cellulose-containing material, or a combination thereof, and includes functionalized carbon.

The efficacy of several biochars made from various ratios of algae and swine manure as anti-aging additives to delay asphalt aging is demonstrated. All indexes show that asphalt samples containing biochar had lower aging levels compared to samples without biochar, indicating that the presence of biochar delays aging caused by UV radiation. This can be attributed at least in part to the capability of biochar as a free-radical scavenger and UV blocker.

Laboratory tests indicate that functionalized carbon obtained from biowaste is more effective than pristine carbon at delaying aging of bituminous composites. Molecular dynamics (MD) simulation results corroborate laboratory findings showing that even at low concentrations, surface functional groups containing nitrogen and/or oxygen considerably enhance the efficacy of pristine carbon in shielding the underlying layers against the diffusion of reactive oxygen species (ROS) such as hydrogen peroxide (H₂O₂).

In a first general aspect, a composite includes a polymeric material or emulsion and biochar. The composite can include 1 wt % to 20 wt % of the biochar.

Implementations of the first general aspect can include one or more of the following features.

The biochar can include biochar from algae, food waste, animal waste, cellulose-containing material, or a combination thereof. In some cases, the cellulose-containing material includes palm sheath. In some implementations, the biochar is functionalized with nitrogen-containing groups or compounds, oxygen-containing groups or compounds, or both. A building material can include the composite of the first general aspect.

In a second general aspect, making a composite includes combining biochar with a polymeric material or emulsion to yield a modified polymeric material or emulsion, and homogenizing the modified polymeric material or emulsion to yield the composite.

Implementations of the second general aspect can include one or more of the following features.

The biochar can be a by-product of biofuel production, liquefaction, pyrolysis, or a combination thereof. The liquefaction can include thermochemical liquefaction or hydrothermal liquefaction. In some cases, the composite includes 1 wt % to 20 wt % of the biochar. In some implementations, the biochar includes biochar from algae, food waste, animal waste, cellulose-containing material, or a combination thereof.

In a third general aspect, functionalizing biochar includes removing contaminants from the biochar to yield decontaminated biochar, oxidizing the decontaminated biochar to yield oxidized biochar, and functionalizing the oxidized biochar.

Implementations of the third general aspect can include one or more of the following features.

Removing contaminants from the biochar can include sonicating the biochar to yield purified graphene oxides. Some implementations further include exfoliating graphene sheets from the purified graphene oxides. Oxidizing the biochar can include contacting the biochar with an acid. In some implementations, functionalizing the biochar includes contacting the oxidized biochar with a solution including a source of functional groups. Some cases further include coupling the functional groups to the oxidized biochar. The source of functional groups can include a source of amine groups or a source of phosphorus. The source of amine groups can include urea.

In a fourth general aspect, making nitrogen-doped biochar includes combining urea and wood residue to form a mixture, and heating the mixture in an oxygen-free environment to form the nitrogen-doped biochar. A weight ratio of the urea to the wood residue can be in a range of about 0.1:1 to about 10:1.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A and 1B show crossover modulus and crossover frequency, respectively, for different aging levels of asphalt with and without biochar.

FIGS. 2A and 2B show aging rate calculated based on the slope of crossover modulus and crossover frequency, respectively, as a function of aging time.

FIG. 3 shows activation energy for asphalt with and without biochar as a function of ultraviolet (UV) aging.

FIG. 4 shows activation energy-based aging rate for asphalt with and without biochar.

FIGS. 5A and 5B show carbonyl index values and sulfoxide index values, respectively, for samples exposed to UV aging.

FIG. 6 shows the Chemical Aging Index (CAI) based aging rate based on the slope of the CAI during each time interval.

FIG. 7 shows crossover modulus for all samples subjected to 0 hr and 200 hr UV aging.

FIG. 8 shows the chemical aging for all samples subjected to 0 hr and 200 hr UV aging.

FIG. 9 shows a plot of the efficacy of functional groups ethylenediamine and nonadecanamide in reducing the diffusion of H₂O₂ molecules into biochar.

FIG. 10 shows a comparison of maximum adsorptions of six gas compounds on four nitrogen-containing active zones of an algal biochar.

FIG. 11 shows comparison of average adsorptions of six gas compounds on four nitrogen-containing active zones of an algal biochar.

### DETAILED DESCRIPTION

Aging of composites, for example, non-combustion sources such as polymeric materials and emulsions, is implicated in many distresses of materials used in the construction. In one example, bitumen is the glue used in roof shingles and asphalt pavement. Aged bitumen has a loss of stress relaxation capacity and an increased propensity to thermal cracking due to excessive hardening. Bitumen is part of the asphalt composites used in roofing and pavements, which undergo intense weathering during their service life. The degree of aging of asphalt composites used in roofing and pavements depends at least in part on the geographic location, temperature, solar radiation, and the composition of materials. Aging is a prevalent type of failure in asphalt composites used in regions with high solar irradiance. Construction materials in regions with high solar irradiance are susceptible to accelerated aging, due at least in part to high solar irradiance and high temperatures. Increased ultraviolet (UV) radiation decreases the outdoor service life of construction materials such as plastics, rubber, and wood materials. This is especially notable for asphalt composites having high UV blocking capacity; the UV heats the asphalt matrix and negatively impacts its thermomechanical properties.

UV exposure of bitumen generates reactive oxygen species (ROS) such as hydrogen peroxide (H₂O₂) that can decompose into free radicals. These free radicals react rapidly with oxygen to form a variety of new products including polar oxygenous (O-containing) compounds such as ketones, sulfoxides, and carboxylic acids. If diffused into the bituminous structure of pavements, free radicals and their derivative compounds can accelerate age hardening in pavements through mechanisms such as chain scission, aromatization, carbonation, and loss of volatiles. Accelerated age hardening decreases the long-term performance of pavements and reduces the sustainability of the built environment.

Biochar additives for bitumen composites as well as bitumen composites with biochar additives are disclosed. Biochar is a by-product of biofuel production. Biochar includes residues from pyrolysis and thermochemical or hydrothermal liquefaction of biomass, such as algae, biowaste (e.g., food waste and animal waste, agricultural waste), cellulose-containing matter (e.g., palm sheath or wood such as pine and juniper), or any combination thereof. Biochars may have different chemical properties and may provide different advantages. For example, algal biochar is rich in protein and nucleic acids, and animal waste biochar is rich in lipids. The formation of biochar results in functionalization of carbon in the biochar.

Biochar functions as a solid sorbent, free-radical scavenger, and ultraviolet blocker when mixed with various non-combustion composites. The efficacy of biochar as a free radical scavenger and ultraviolet blocker is attributed at least in part to high surface area of the biochar and functional groups in the biochar. Functional groups (or compounds) include oxygen-containing functional groups (or compounds) such as alcohols (e.g., phenols), ketones, lactones, and carboxylic acids and nitrogen-containing functional groups (or compounds) such as amines (e.g., ethylenediamine, pyrrole, pyridine), amides (e.g., nonadecanamide), diimides, and azides. In some cases, the biochar contains polyaromatic rings connected through polyphosphate bridges. Functional groups on the biochar can promote adsorption and decomposition (e.g., through deamination and decarboxylation) of organic compounds (e.g., air pollutants) emitted from bitumen. The organic compounds can be precursors to secondary organic aerosols. Examples of these organic compounds include hydrocarbons, oxygen-containing compounds such as benzoic acid, benzofuran, and hexanal), and sulfur containing compounds such as dibenzothiophene, 3-pentythiophene, and hexanethiol). The biochar micropores and the heteroatoms present in the functional compounds or groups work synergistically to enhance gas adsorption by the biochar.

The biochar can be combined with (e.g., embedded in) various composites to delay ultraviolet aging and reduce air pollution from these composites. In particular, these composites are considered to be non-combustion sources that emit submicron atmospheric aerosols such as volatile and semi-volatile organic compounds and ozone precursors. Examples of composites that benefit from the addition of biochar include polymeric materials and emulsions, such as coatings, paints, and sealants. Other examples include pavement-related compositions, such as asphalt, bitumen (various grades), and fog seal, and construction elements such as buildings (including roofing), building materials, and furniture. Bitumen and bitumen blends are described here as non-limiting examples of such composites.

Bitumen composites with biochar additives can decrease degradation caused by exposure to UV radiation (i.e., sunlight). Biochar can be combined with a polymeric material or emulsion (e.g., neat asphalt) and homogenized to yield a composite. The biochar can be in a range of about 1 wt % to about 20 wt % (e.g., 1 wt % to 15 wt %, 1 wt % to 10 wt %, 5 wt % to 15 wt %, 1 wt % to 5 wt %, 5 wt % to 10 wt %, 10 wt % to 15 wt %, 15 wt % to 20 wt % or 5 wt %, 10 wt %, 15 wt %, or 20 wt %) of the composite. In one example, a bitumen composite including about 5 wt % biochar decreased degradation can be manifested as an improvement in aging resistance of about 35% to about 60%, resulting in a longer outdoor service life of the bitumen composite. In some cases, the functionalized biochar can serve as a replacement for asphalt.

Biochar can be functionalized by removing contaminants from the biochar (e.g., by sonication), oxidizing the decontaminated biochar, and functionalizing the oxidized biochar.

To purify graphene oxides in biochar and exfoliate graphene sheets from the purified graphene oxides, the biochar can be sonicated (e.g., for 30 seconds at 100% amplitude). Following sonication, the biochar can be separated from solvent (e.g., using filtration) and the filtrate dried (e.g., under vacuum at 60° C. for 8 hours). Following drying, the sonicated biochar can be sieved (e.g., to its original size) to eliminate graphene oxides and other contaminants, thereby yielding decontaminated biochar.

Oxidation of the decontaminated biochar increases the number of active sites that can be functionalized. In one example, oxidation with acid (e.g., sulfuric acid or nitric acid) is achieved by a process in which an acidic solution (e.g., 85 wt %) is mixed with the sonicated biochar (e.g., in a range from 30 wt % to 90 wt %) for duration of time (e.g., 3 hours) at a temperature above room temperature (e.g., 80° C.). The product is separated (e.g., using filtration), and dried (e.g., under vacuum at 60° C. for 8 hours).

The active sites can be functionalized with selected functional groups. In one example, amine groups can be coupled to the oxidized biochar. A solution including the oxidized biochar and an amine source (e.g., urea, methylamine, ethylamine, diethylamine, trimethylamine, aniline, benzylamine) can be mixed for a duration of time (e.g., 8 hours) at a temperature above room temperature (e.g., 60° C.). The product is separated (e.g., by filtration), dried, and washed with deionized water. Similar procedures can be used to functionalize the biochar with phosphorus groups (e.g., using a phosphorus source such as phosphorus acid).

A single-step synthesis involving direct nitrogen-functionalization of wood residue can be used to prepare nitrogen-doped biochar. Urea and wood residue are mixed at a weight ratio of about 0.1:1 to about 10:1 (e.g., 2:1) and placed in an alumina crucible. The crucible is covered (e.g., with aluminum foil) and placed in the reactor tube of a tube furnace. The reactor tube is purged with nitrogen to remove oxygen from reactor tube and its contents, including the sample mixture. The sample mixture is then calcined by heating in the oxygen-free reactor tube. In one example, the heating includes ramping the temperature starting from room temperature at a ramping rate of 10° C. min⁻¹ until 800° C. is reached, and maintaining 800° C. for 2 h. After the calcination heating process is completed, the crucible is removed from the tube furnace and the product is collected. In one example, the product is then washed several times with deionized (DI) water, dried in an oven at 60° C. and stored in a container prior to use. The urea:wood residue weight ratio can be varied to change the N-functional group concentration on the carbon surface of the biochar.

Chemical diffusion of oxygen, water, and other reactive species through bitumen is a part of aging mechanisms. Computational modelling (e.g., molecular dynamics (MD) simulations) can be used to examine the diffusion of oxygen, water, and hydrogen peroxide through a model bitumen medium or along bitumen interfaces with other materials. Fillers such as clay nanoparticles can slow diffusion in materials by acting as physical barriers, forcing molecules to travel longer paths by traveling around the clay particles. Both mineral and carbonaceous filler materials are typically more polarizable than the surrounding bitumen matrix, so polar reactive molecules may be more strongly attracted to them by van der Waals interactions. Biochar (or surface-treated biochar) can be more likely than mineral fillers to contain polar groups, since mineral fillers are already fully oxidized. As such, biochar can be more effective than typical mineral fillers at adsorbing polar molecules and reacting with or neutralizing oxygen or peroxides. Computational modeling can provide parameters for biochar antiaging additives for bituminous composites including surface treatment to increase its dosage efficiency.

### EXAMPLES

To test the efficacy of biochar in limiting thermo-oxidative aging in bitumen, fresh bitumen (e.g., Superpave PG64-22, a grade commonly used in the U.S.) can be mixed with a specified amount of biochar and subjected to standard laboratory aging. Short-term aging can be simulated using a rolling thin-film oven (RTFO), American Society for Testing and Materials (ASTM) D2872. To simulate long-term aging, RTFO aging can be followed by 20 h in a pressure aging vessel (PAV, ASTM D6521). An additional cycle of PAV aging (40 h total, or 2PAV) may be used to better represent the extended aging of asphalt pavement through its service life.

Rheological and chemical characterization of biochar-bitumen blends can be used to quantify the extent of degradation. A dynamic shear rheometer (DSR) can be used to measure the complex modulus G* before and after aging and to calculate the rough aging index (AI) metric given by Eq. 1:

AI=G*_{aged}/G*_{unaged} (1)

A common chemical metric of oxidation is the carbonyl index (I_{C═0}) calculated from integrated peak intensities of FTIR spectra, although exact ways of calculating I_{C═O} can vary. The difference in I_{C═O} between aged and unaged samples gives the chemical aging index of Eq. 2:

$$Δ {I}_{C = O} = \frac{{( {I}_{C = O} )}_{RTFO / PAV} - {( {I}_{C = O} )}_{u n a g e d}}{{( {I}_{C = O} )}_{u n a g e d}} \qquad ( 2 )$$

The lower values of AI and ΔI_{C═O} indicate better aging resistance of the bitumen blend. Table 1 shows the effects of three different types of biochar (wood, algae, and manure) on aging resistance of bitumen. The three biochar types demonstrated performance superior to that of control bitumen; however, biochar efficacy varied based on the source, with algae and wood-based showing higher resistance than manure-based biochar.

TABLE 1
Thermo-oxidative aging of biochar-bitumen blends

| | | Bitumen containing | | |
|---|---|---|---|---|
| Aging index after 200 hr | Control | various biochar | | |
| of accelerated aging | Bitumen | Wood | Algae | Manure |
| Rheological aging index (AI) | 44.96 | 17.46 | 24.75 | 31.09 |
| Chemical aging index (ΔI_{C═O}) | 40.36 | 23.27 | 20.82 | 38.62 |

Typically, the use of solid additives in bitumen is limited to 10-15% by the weight of the base bitumen (e.g., to minimize phase separation which is exacerbated by aging). In addition, the higher concentration of solid could lead to excessive stiffness in the bituminous composites promoting susceptibility to cracking. The stability of each blend can be evaluated with a hot-storage test. The test follows ASTM D36 and can be used to test the susceptibility of bitumen blends to phase separation or sedimentation over time (storage stability). Typically, this test involves filling an aluminum foil tube (2.5 cm diameter, 14 cm height) with bitumen and storing it vertically at 163° C. for 48 h. The softening point (ASTM D36) is measured for the material in the top and bottom thirds of the tube. A softening point difference ΔS<2.2° C. is considered a stable blend.

### Example 1

This example demonstrates the use of functionalized carbon, referred to as biochar, as a free radical scavenger. The biochar was made from thermochemical liquefaction of a blend of algae and manure. Efficacy of the biochar as a free-radical scavenger and ultraviolet (UV) blocker qualifies it as an anti-aging additive in construction including roofing shingles made from bituminous composite. Results show that the addition of biochar to bitumen reduced aging of bitumen. All tested biochars made from various relative proportions of algae and swine manure were found to be effective at reducing the extent of aging; however, the biochar made from algae alone was the most effective. The latter result could be attributed to the high surface area and rich phenol functional groups in algal biochar, turning it into an effective free-radical scavenger.

Materials and Methods. The neat asphalt was a PG 64-10 graded asphalt (Table 2). The biochar was produced through thermochemical liquefaction of various dosages of algae and swine manure.

TABLE 2
Properties of PG 64-10 binder

| | Test and Temperature | Result | |
|---|---|---|---|
| Original Binder | Flash Point | 302° | C. |
| | Rotational Viscosity @135° C. | 0.402 | Pa-s |
| | Dynamic Shear, G*/sinδ @64° C. | 1.173 | kPa |
| PAV aged Binder | Dynamic Shear, G*sinδ @ 31° C. | 1182 | Kpa |
| (aged @100° C.) | Stiffness @ 0° C. | 28 | MPa |

| | |
|---|---|
| m-value @ 0° C. | 0.468 |

Cyanidioschyzon merolae (C. merolae MS1-YNP, or “CM”) liquefied by thermochemical liquefaction was used as an example of algal biochar. The microalgae had a moisture content of 70 wt % and an ash content of 1.76 wt %, while the swine manure had a moisture content of 36.21 wt % and an ash content of 35.75 wt %. All the chemicals (dichloromethane, hexane, and acetone) used in the process were commercially purchased from Sigma Aldrich. Hydrothermal liquefaction (HTL) was performed at a temperature of 330° C. with a solid loading of 20 wt %. To perform the test, 10 grams equivalent of dry biomass along with the required amount of distilled water to make 50 mL slurry were loaded into the reactor. The slurry was then heated to the desired temperature with an initial pressure of 9 MPa provided by ultra-high pure (UHP) nitrogen. UHP nitrogen was also used to purge the reactor headspace and create an inert atmosphere. Once the reactor reached the desired temperature, the residence time of 30 min was left for the reaction to complete. Upon completion, the reactor was cooled to room temperature and depressurized; 25 mL of dichloromethane was added to the reactor. The contents of the reactor were transferred into the filtration unit for separation. The liquefaction yielded four major product fractions: biocrude oil, biochar, aqueous fraction (water-soluble compounds), and gaseous fraction.

20 g of asphalt was heated to 135° C. for 30 minutes to liquefy the asphalt. 1 g of biochar prepared as described herein (5% by weight of neat asphalt) was combined with the asphalt to yield a mixture. The mixture was placed on a hotplate at 135° C. and blended with a spatula for 5 minutes to ensure homogenous mixing.

Biochar was added to bitumen at a 5% dosage by weight of the neat asphalt. Referring to Table 3, the neat asphalt (without biochar) was labeled as 0-0; the first number shows the algae concentration and the second number shows the swine manure concentration in the biomass feedstock that was used to produce the biochar. The concentration of the components of algae and swine manure bio-oil were obtained through gas chromatography-mass spectroscopy as shown in Table 4 and thin-layer chromatography with flame ionization detection shown in Table 5.

TABLE 3
Acronyms of samples

| Sample name | Algae (%) | Swine manure (%) |
|---|---|---|
| 0-0 | 0 | 0 |
| 0-100 | 0 | 100 |
| 20-80 | 20 | 80 |
| 50-50 | 50 | 50 |
| 80-20 | 80 | 20 |
| 100-0 | 100 | 0 |

TABLE 4
Molecules of bio-oil (from GC-MS)
from which biochar was extracted

| | |
|---|---|
| Molecules | % Concentration |

Algae

| | |
|---|---|
| Heptane, 2,4-dimethyl- | 6.7 |
| Undecane, 3,7-dimethyl- | 6.3 |
| Octane, 4-methyl- | 6.1 |
| Phenol | 5.2 |

Swine Manure

| | |
|---|---|
| p-Cresol | 1.5 |
| 4-ethyl- | 1.4 |
| Phenol | 1.1 |
| 4-ethyl-2-methoxy- | 0.6 |

TABLE 5
Solubility-based compounds of bio-oil (through
TLC-FID) from which biochar was extracted¹

| Sample | Saturates | Aromatics | Resins | Asphaltenes |
|---|---|---|---|---|
| 0-100 | 1.93 | 3.06 | 71.24 | 23.76 |
| 20-80 | 0.51 | 2.45 | 8.29 | 88.75 |
| 50-50 | 0.83 | 0.25 | 72.67 | 26.25 |
| 80-20 | 0.00 | 1.31 | 45.09 | 53.60 |
| 100-0 | 0.00 | 15.37 | 83.48 | 1.13 |

¹All entries given in % concentration.

Ultraviolet Aging Method. The unaged samples were exposed to UV radiation to provide accelerated aging. To prepare samples, 10 g of the unaged specimen was evenly spread on a steel pan (140 mm diameter) to make a film 0.65 mm thick. The pan was then placed in a UV chamber 10 cm away from the lamp; the lamp had a UV radiation intensity of 0.71 W/m². UV exposure continued for 200 hr at 65° C. Samples were collected at time intervals of 50 hr, 100 hr, and 200 hr.

Dynamic Shear Rheometer. The elastic and viscous properties of each sample were measured using an Anton Paar Rheometer MCR 302 following ASTM D7175. Tests were conducted using an 8-mm parallel plate spindle at a 0.1% strain rate and frequencies ranging from 0.1 to 100 rad/s at 10° C. Throughout the test, stress and strain were measured, and data were used to calculate the shear modulus (G*) and phase angle (δ) based on Eq. 3. The complex shear modulus (G*) is a measure of a material's resistance to deformation when repeatedly sheared, and δ is the time lag between stress and strain. From the data, the modulus and frequency at which the phase angle is 45 degrees were determined as crossover values. (At the crossover point, the elastic modulus (G′) and viscous modulus (G″) are equal.)

$${G}^{*} = \frac{{τ}_{max}}{{γ}_{max}} \qquad ( 3 )$$

in which

$${γ}_{max} = ( \frac{θ r}{h} ) and {τ}_{max} = \frac{2 T}{π {r}^{3}}$$

where:
γₘₐₓ=maximum strain
τₘₐₓ=maximum stress
T=maximum applied torque
r=radius of the sample
θ=deflection (rotational) angle
h=height of the sample

Activation-Energy-Based Aging Index. The activation energy of unaged and UV-aged samples was calculated based on the zero-shear viscosity; the activation energy was then used to develop the activation-energy-based aging index. To measure zero shear viscosity, rheometry was conducted using a shear rate sweep (using an 8-mm parallel plate with a 2 mm gap) at 50, 60, and 70° C. The collected data was used to calculate the activation energy using Eq. 4

$$ln η = ln A + \frac{{E}_{f}}{R} \frac{1}{T} \qquad ( 4 )$$

where:
η is the viscosity of asphalt in Pa·s
E_{f} is the flow activation energy (KJ·mol⁻¹)
R is the universal gas constant (8.314×10-3 KJ·mol⁻¹·K⁻¹)
T is the temperature
A is constant.

Fourier Transform Infrared (FTIR) Spectroscopy. A Bruker FTIR spectrometer was used to characterize the functional groups of unaged samples and samples subjected to different UV aging levels. Before starting the test, the FTIR diamond crystal surface was cleaned with isopropanol. The background spectrum was collected and subtracted from the sample spectra. Each FTIR spectrum was collected from 400 to 4000 cm⁻¹ wavenumbers with a resolution of 4 cm⁻¹ with 32 scans. To analyze the peaks and calculate the area under each peak, OMNIC software was used.

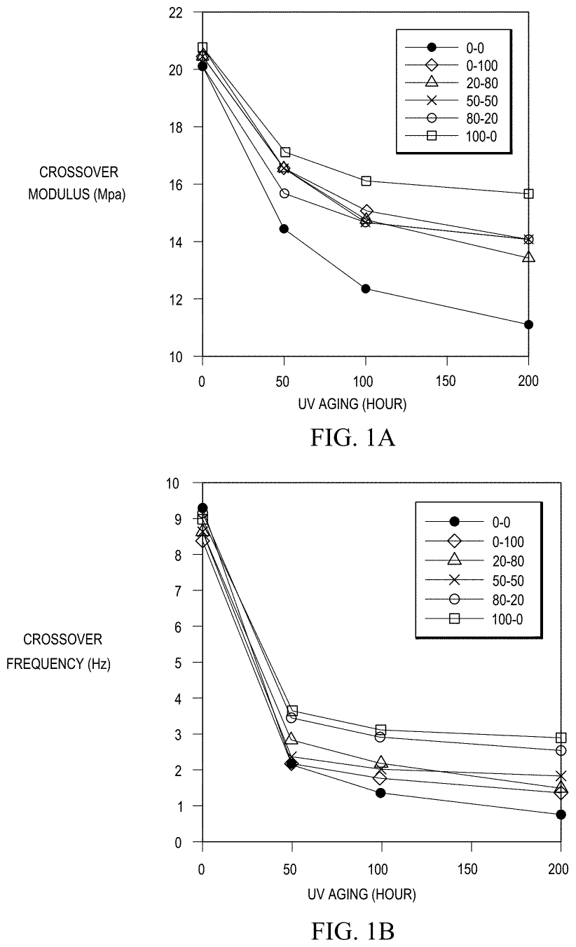

Crossover-Modulus-Based Aging Index. The crossover-modulus-based aging index was calculated for samples aged from 0 to 200 hours under UV exposure. FIG. 1A shows that before aging, all samples show approximately the same value for crossover modulus. The crossover modulus shows a sharp decrease after 50 hours of UV aging, and it continues to decrease at a slower rate through 200 hours of UV aging. As shown in FIG. 1B, crossover frequency has the same trend. As shown in FIGS. 1A and 1B, asphalt without biochar (0-0) showed the highest change in modulus throughout UV aging. Asphalt samples with biochar showed a lower change in properties compared to the asphalt without biochar, indicating improved resistance to aging due to the addition of biochar. The highest resistance to UV aging (the lowest aging index) was found for the asphalt having biochar made from algae alone (the sample referred to as 100-0, algae-manure ratio). The data was used to calculate the aging index using Eq. 5 for each scenario as shown in Table 6. The asphalt without biochar has the highest aging index of 28% after 50 hr and 45% after 200 hr. All samples having biochar showed aging index values lower than neat asphalt, with algal biochar (100-0 scenario) showing the lowest aging index of 17% after 50 hr and 25% after 200 hr of aging. This indicates that a 45% improvement in aging resistance through 200 hours of aging can be achieved by introducing algal biochar.

$$Rheological Aging Index = \frac{u naged crossover modulus - aged crossover modulus}{u naged crossover modulus} \times 100 \qquad ( 5 )$$

TABLE 6
Crossover-modulus-based rheological aging index

| | 0-0 | 0-100 | 20-80 | 50-50 | 80-20 | 100-0 |
|---|---|---|---|---|---|---|
| Aging Index % for 0-50 hr | 28.17 | 18.92 | 19.03 | 20.84 | 21.87 | 17.45 |
| Total Aging Index % for | 44.96 | 31.09 | 34.31 | 32.85 | 29.93 | 24.75 |
| 0-200 hr | | | | | | |

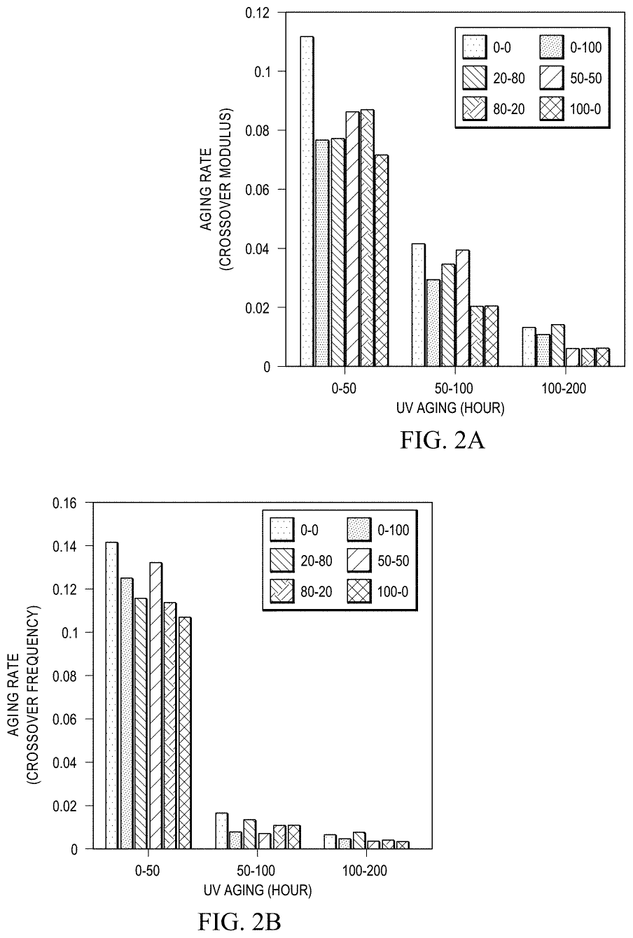

To further evaluate the aging rate for each aging interval (0 to 50 hours, 50 to 100 hours, and 100 to 200 hours), the change of the crossover modulus and crossover frequency during the aging interval was determined using the slope of the plot at each aging interval. As shown in FIGS. 2A and 2B, the aging rate of asphalt without biochar was found to be higher than all the asphalt samples having biochar. Asphalt samples having biochar performed differently depending on the type of biochar. The lowest aging rate (highest resistance to UV aging) was found for biochar made from algae alone (the 100-0 sample).

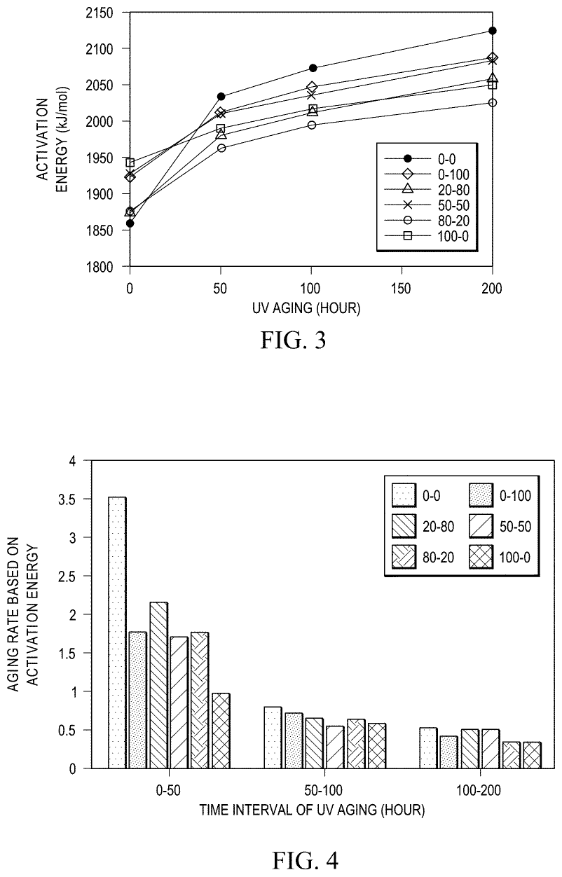

Activation-Energy-Based Aging Index. FIG. 3 shows the activation energy plot for all samples after UV aging of 0 to 200 hours. As shown in FIG. 3, the presence of biochar increased the activation energy as expected, since the asphalt became stiffer overall when biochar was present. To test the aging effect, the change of properties during each aging period was monitored. The data was used to calculate the activation energy-based aging index using Eq. 6 for each scenario show in Table 7. Neat asphalt had an increase in activation energy of 9% after 50 hr and 14% after 200 hr. Among asphalt samples that contained biochar, the algal biochar had the lowest increase in activation energy of 2.48% after 50 hr and 5.56% after 200 hr. The 5.56% increase after 200 h represents a 61% reduction compared to the 14.36% increase for asphalt without biochar after 200 hr aging.

$$Activation Energy - Based Aging Index = \frac{aged activation energy - u naged activation energy}{u naged activation energy} \times 100 \qquad ( 6 )$$

TABLE 7
Activation-energy-based aging index

| | 0-0 | 0-100 | 20-80 | 50-50 | 80-20 | 100-0 |
|---|---|---|---|---|---|---|
| Aging Index % for 0-50 hr | 9.49 | 4.63 | 5.70 | 4.38 | 4.69 | 2.48 |
| Total Aging index % for | 14.36 | 8.54 | 9.95 | 8.26 | 8.08 | 5.56 |
| 0-200 hr | | | | | | |

To evaluate the aging resistance of biochar, the aging rate was defined as the slope of each segment (0 to 50 hr, 50 to 100 hr, and 100 to 200 hr); these slopes are plotted in FIG. 4. As shown in FIG. 4, the aging rate was the highest for the 0-0 sample, and all samples with added biochar showed a lower aging rate compared to the neat sample. FIG. 4 also shows that the highest aging rate occurs during the first 50 hr of aging, and the rate of change in activation energy slows during the subsequent intervals.

Chemical Aging Index. FTIR spectroscopy was used to track the extent of change in the chemical structure of asphalt during aging. To quantify the change, Eqs. 7 and 8 were used to calculate the carboxyl functional groups and sulfoxide functional groups, respectively, of all samples.

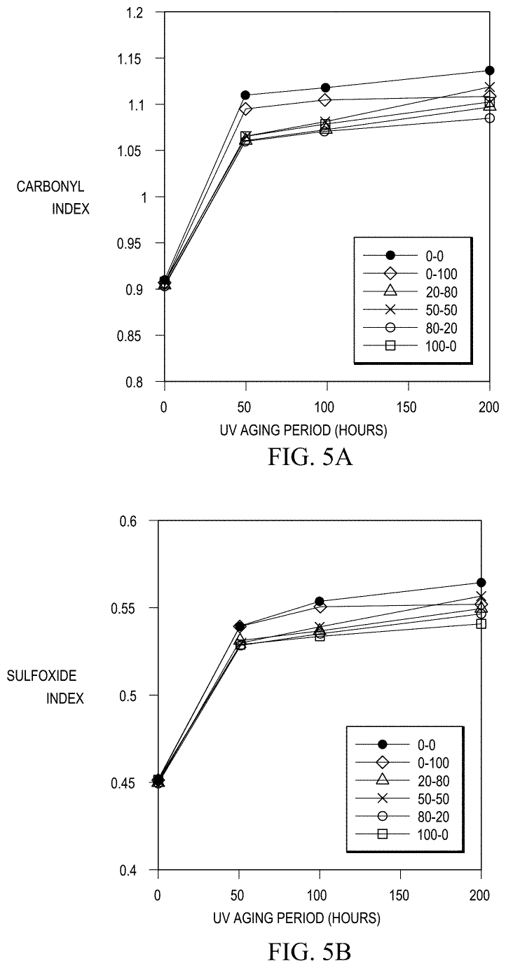

The carbonyl and sulfoxide index results for specimens exposed to UV aging are shown in FIGS. 5A and 5B, respectively.

$$Carbonyl Index = \frac{Area under curve from 1680 - 1800 {cm}^{- 1}}{Area under curve from 600 - 4000 {cm}^{- 1}} \times 1000 \qquad ( 7 )$$

$$Sulfoxide Index = \frac{Area under curve from 960 - 1050 {cm}^{- 1}}{Area under curve from 600 - 4000 {cm}^{- 1}} \times 1000 \qquad ( 8 )$$

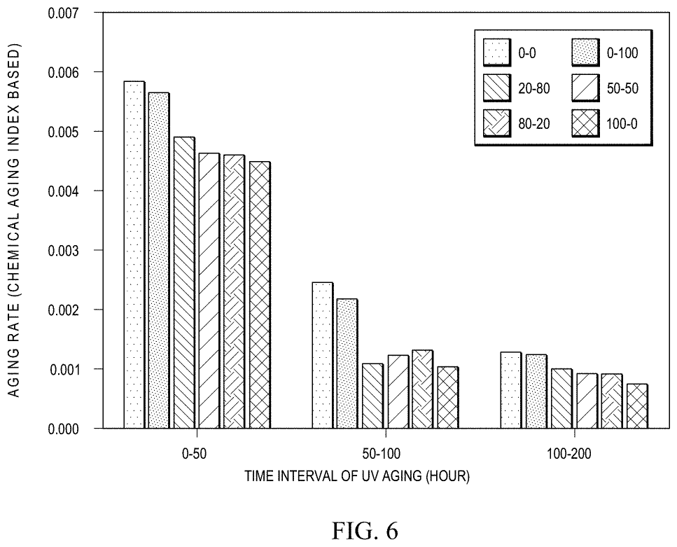

As shown in FIGS. 5A and 5B, all samples had similar values for the Carbonyl Index and Sulfoxide Index before aging, since the presence of biochar did not contribute to either of the above indexes before aging. When asphalt samples were exposed to UV aging, their Carbonyl Index and Sulfoxide Index increased, with the largest increase happening in the first 50 hr. Asphalt samples without biochar showed a higher increasing rate than asphalt samples with biochar. To facilitate comparing studied scenarios, the sum of the two indexes was calculated at each aging interval and referred to as the Chemical Aging Index (CAI), following methods generally known in the art. The asphalt sample without biochar had a CAI of 22% after 50 hr and 40% after 200 hr of aging shown in Table 8. Among all asphalt samples with biochar, the sample containing algal biochar (100-0 scenario) had the lowest CAI value of 17% after 50 hr and 26% after 200 hr of aging. This represents a 36% improvement in the aging resistance of asphalt due to the addition of algal biochar. FIG. 6 shows the aging rate based on changes in the chemical aging index over time.

TABLE 8
Chemical Aging Index (CAI) (%).
CAI = Carbonyl index + Sulfoxide index

| | 0-0 | 0-100 | 20-80 | 50-50 | 80-20 | 100-0 |
|---|---|---|---|---|---|---|
| CAI (%) for 0-50 hr | 21.75 | 21.11 | 18.29 | 17.17 | 17.08 | 16.69 |
| CAI (%) for total 0-200 hr | 40.36 | 38.62 | 29.82 | 28.34 | 28.61 | 25.91 |

As shown in FIG. 6, the CAI-based aging rate was consistently lower for asphalt samples with biochar compared to those without biochar. All the aging indexes calculated for different aging levels for the sample with no biochar and the sample with algal biochar (100-0) are summarized in Table 9.

TABLE 9
Summary of calculated aging indexes after 200 hr of UV aging

| | Rheology | Activation-Energy- | Chemical |
|---|---|---|---|
| | Aging Index | based Aging Index | Aging Index |
| No Biochar (0-0) | 44.96 | 14.36 | 40.36 |
| Algal Biochar | 24.75 | 5.56 | 25.91 |
| (100-0) | | | |
| % Improvement | 45 | 61 | 36 |

### Example 2

Laboratory tests and molecular dynamics simulations were conducted to compare the efficacy of pristine carbon and functionalized carbon in delaying the aging of bituminous composites. The delay in aging was measured based on changes in the chemical and rheological properties of modified bitumen samples exposed to UV aging. The underlying molecular mechanisms that delay aging were analyzed by computing the extent of diffusion of free radicals through an amorphous graphite film in pristine and functionalized forms. The laboratory results indicate that functionalized carbon obtained from biowaste is more effective than pristine carbon at delaying aging. The simulation results corroborate laboratory findings showing that even at low concentrations, surface functional groups such as amines and amides considerably enhance the efficacy of pristine carbon in shielding the underlaying layers against the diffusion reactive oxygen species such as hydrogen peroxide (H₂O₂). At high concentrations (e.g., 10 wt %), amines were found to be more effective than amides at reducing the diffusion rate of H₂O₂. This indicates that the scavenging efficacy of carbonaceous particles can be optimized by selected bio-grafting.

Materials. The unaged neat bitumen used was a PG 64-10 graded bitumen described in Table 2. The carbonaceous particles were produced via hydrothermal liquefaction of biomass waste (algae) Hydrothermal liquefaction (HTL) was performed at 330° C. in a 250-ml stainless steel benchtop batch reactor (Parr Instrument Company, Moline, Ill.) equipped with a magnetic stirrer, a 4843 controller, and a jacketed heater. The working volume of the system was set to a maximum of 125 ml. The biochar was produced at 20% solid loading (25 g dry weight) in all the HTL tests. The algal biochar that was produced served as functionalized carbon (FC). In contrast, the pristine carbon (PC) was produced from woody biomass (wood-based biochar). The samples were prepared by introducing anti-aging agents (biochar) at 5 wt % to the unaged neat bitumen; the two were then blended using a shear mixer at 135° C. for five minutes. The blended samples were labeled Neat Binder (NB), Functionalized Carbon-modified Binder (FCB), and Pristine Carbon-modified Binder (PCB).

Ultraviolet (UV) aging. The unaged samples were exposed to UV radiation to accelerate aging. A QUV Accelerated Weathering Tester manufactured by the Q-Lab Corporation (Westlake, Ohio, USA) was used to perform the UV aging of the samples. To prepare samples, 10 g of the unaged specimen (NB, FCB, or PCB) was evenly spread on a steel pan 140 mm in diameter, to make a 0.65-mm film. The pan was then placed in the chamber of a UV accelerator 100 mm from the lamp; the lamp used in the UV accelerator had a UV radiation intensity of 0.71 W/m² at 313 nm wavelength. UV exposure continued for 200 hr at 65° C.

Dynamic shear rheometer (DSR). The elastic and viscous properties of each sample were measured using an Anton Paar Rheometer MCR 302 following (ASTM D7175-15, 2015). The tests were carried out using an 8-mm parallel-plate spindle at a 0.1% strain rate and frequencies ranging from 0.1 to 100 rad/s at 10° C. The measured stress and strain data were used to calculate the shear modulus (G*) and phase angle (δ) based on Eq. 3. From the data, the modulus and frequency at which the phase angle was 45 degrees were determined as crossover values. At the crossover point, the elastic modulus (G′) and viscous modulus (G″) are equal. Considering that progressive aging leads to significant changes in polydispersity as asphaltene molecules form nanoaggregates, crossover values are deemed appropriate to track the evolution of bitumen not only during aging but also during rejuvenation. Provided that the crossover frequency and corresponding crossover moduli are measured at the same temperature for all bitumen specimens in comparison, the crossover values can properly detect and compare the extent of the delay in aging as calculated by Eq. 3.

Rheological aging index. The rheological aging index was calculated based on the change in the crossover modulus which has been shown to be sensitive to aging. The rheological aging index for each scenario was calculated by Eq. 5.

Fourier transform infrared (FTIR) spectroscopy. A Bruker FTIR spectrometer (Manufactured by Bruker Corporation) was used to characterize the functional groups of unaged samples and samples subjected to different UV aging levels. Before starting the test, the FTIR diamond crystal surface was cleaned with isopropanol. The background spectrum was collected and subtracted from the sample spectra. Each FTIR spectrum was collected from 400 to 4000 cm⁻¹ wavenumbers with a resolution of 4 cm⁻¹ with 32 scans. To analyze the peaks and calculate the area under each peak, OMNIC software version 9.2.86 was used.

Chemical aging index. Fourier-transform infrared (FTIR) spectroscopy was used to track the extent of the change in the chemical structure of bitumen during aging. To quantify the change, Eqs. 7 and 8 were used to calculate the carboxyl functional groups and sulfoxide functional groups, respectively, of all samples. The chemical index and chemical aging index, respectively, were calculated using Eqs. 9 and 10.

$$Chemical Index = Carbonyl Index + Sulfoxide Index \qquad ( 9 )$$

$$Chemical Aging Index = \frac{Aged chemical index - U naged chemical index}{U naged chemical index} \times 100 \qquad ( 10 )$$

Molecular dynamics simulations. To analyze the efficacy of amide and amine functional groups at protecting biochar against the diffusion of hydrogen peroxide (H₂O₂), molecular dynamics simulations were carried out using nonadecanamide (C₁₉H₃₉NO) and ethylenediamine (C₂H₈N₂) as representatives of amide and amine functional groups. Biochar was modeled as an amorphous graphite film. The following steps were taken to construct the film: 1) a stack of five graphene sheets of dimensions 5 nm×5 nm with an interlayer spacing of 0.335 nm was placed in the simulation box; 2) the temperature was increased from 300 K to 6,000 K using the Nose-Hoover (NH) thermostat over 50 ps with the volume held constant; 3) the temperature was maintained at 6,000 K for another 50 ps to allow for the formation of an amorphous structure; 4) the structure was quenched by lowering the temperature back to 300 K over 0.5 ps, preventing the sheets from restoring their initial configuration; and 5) the temperature was kept at 300 K at constant zero pressure using the NH thermostat for 20 ps to achieve the final structure. A time step of 1 fs was used, and the reactive force-field (ReaxFF) potential was used to represent interatomic interactions.

The diffusion of H₂O₂ into the constructed biochar film in both pristine and functionalized forms was simulated, and the number of H₂O₂ molecules having passed the film at a given time was used to compare different cases. The simulation of H₂O₂ diffusion through pristine biochar involved the following steps: 1) a reservoir of 300 H₂O₂ molecules was positioned at a minimum distance of 4 Å above the biochar film; 2) the temperature was set at 300 K using the Langevin algorithm; and 3) the biochar film and H₂O₂ molecules were allowed to interact with one another for 20 ns under the microcanonical (NVE) ensemble. The Tersoff potential was used to describe the interatomic interactions among carbon atoms in the biochar film, and those among hydrogen and oxygen atoms in H₂O₂ were defined by the Consistent Valence Forcefield (CVFF). The Lennard-Jones (LJ) potential was used to describe nonbonded interactions among the biochar and H₂O₂ constituents.

Biochar films functionalized with different weight concentrations of ethylenediamine and nonadecanamide were also simulated. The Amber force field was used to define interactions within and among ethylenediamine, and those of nonadecanamide were defined with CVFF. Four concentrations were examined: 1.2 wt %, 2.1 wt %, 5.6 wt %, and 10 wt %, corresponding to 5, 9, 25, and 48 ethylenediamine molecules and 1, 2, 5, and 9 nonadecanamide molecules. The simulations ran for 20 ns, and the number of H₂O₂ molecules that passed through the film was counted.

Laboratory test results. FIG. 7 shows the crossover modulus measured for all samples subjected to 0 hr and 200 hr UV aging, based on a dynamic shear rheometer. At the unaged stage, all samples showed approximately the same crossover modulus value. This indicated the biochar (functionalized carbon and pristine carbon) did not have a significant impact on the stiffness of neat bitumen. However, after 200 hr of UV aging, the corresponding crossover modulus values found to be considerably different among the studies scenarios.

Comparison of the rheological aging indices of the samples shown in Table 10 indicates that biochar (both functionalized carbon and pristine carbon) reduced the rheological aging index of the neat bitumen. However, the functionalized carbon was more effective at reducing the rheological aging index (45% vs 13%).

TABLE 10
Rheological aging index for all samples

| | NB | PCB | FCB |
|---|---|---|---|
| Rheological Aging Index | 45 | 39 | 25 |
| % Improvement | — | 13 | 45 |

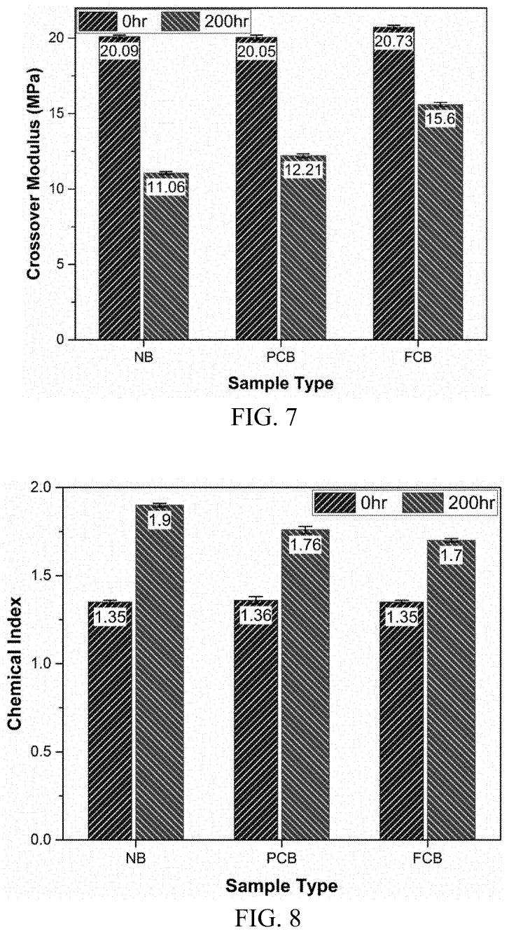

FIG. 8 shows that the chemical aging of all the tested samples increased after 200 hr of UV aging; the neat bitumen showed the highest increase, followed by PCB and FCB. Comparison of the chemical aging indices calculated based on these data shows that both functionalized and pristine carbons delayed the UV aging of the neat bitumen, but the functionalized carbon was more effective.

TABLE 11
Chemical aging index for all samples

| | NB | PCB | FCB |
|---|---|---|---|
| Chemical Aging Index | 40 | 29 | 26 |
| % Improvement | — | 28 | 35 |

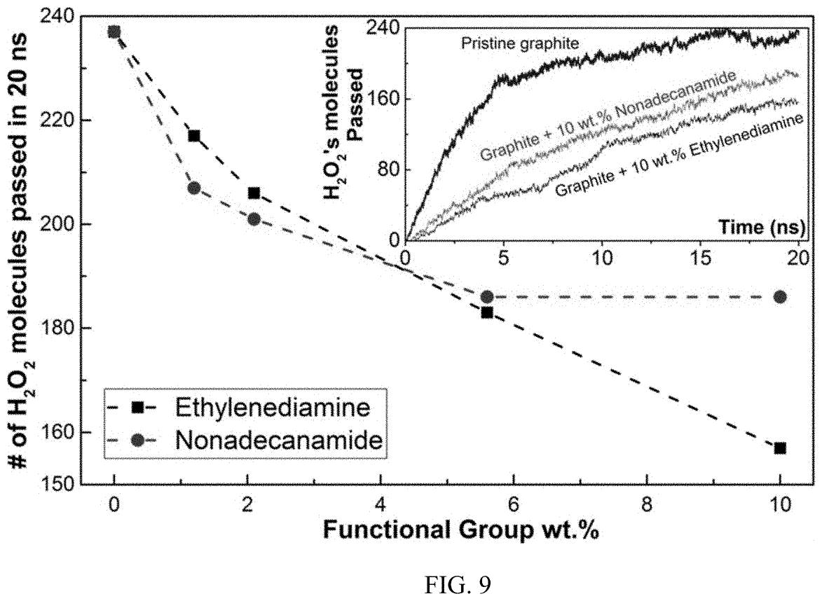

Molecular dynamics simulation results. FIG. 9 shows a plot of the number of H₂O₂ molecules passing through the biochar film during a 20 ns MD simulation run. The inset shows the diffusion history of H₂O₂ molecules into biochar in pristine, 10 wt % nonadecanamide, and 10 wt % ethylenediamine forms. FIG. 9 shows that both ethylenediamine and nonadecanamide were found to be effective at protecting the biochar film against the diffusion of H₂O₂ and exhibited comparable efficacies at concentrations below about 5.6 wt %. However, while the efficacy of nonadecanamide peaked at this concentration, that of ethylenediamine continued to increase approximately linearly over the entire concentration range studied. At a concentration of 10 wt %, for example, ethylenediamine reduced the number of H₂O₂ molecules passed through the biochar film by 34% (from 237 to 157) showing 12% more effectiveness than nonadecanamide (from 237 to 186).

### Example 3

This example describes the use of functionalized carbon derived from an algal feedstock to selectively remove hazardous bitumen emissions, alleviating the side effects of intense sun exposure and high temperatures on air quality. Density functional theory is used to model six organic compounds emitted from bitumen that are precursors to secondary organic aerosols, and their adsorption to the active zones of a model surface of an algal biochar containing N-functional groups of amide, amine, pyrrole, and pyridine is measured. Maximum average adsorption energy toward the nitrogen-rich surface of biochar was shown by benzoic acid and dibenzothiophene (ΔE=−18.1 kcal/mol), and benzofuran showed the minimum (ΔE=−8.3 kcal/mol). All interactions were performed under non-bonding physical interactions, including H-bonding, dipole-dipole, and dispersion forces. The size of the difference between the maximum and minimum average adsorption energies suggests that functionalized carbon acts as a solid sorbent to adsorb hazardous bitumen emissions.

Apart from the role of O-containing functional groups such as phenols, alcohols, ketones, lactones, and carboxylic acids that are normally abundant in biochars, the role of N-containing functionals in algae biochar cannot be overlooked. The O-containing functional groups and N-containing functional groups have been shown to be the factors most influencing the acidity or basicity of the carbon's surface. The N-containing functional groups mainly demonstrate the basic characteristic.

One difference between algae biomass and terrestrial biomass is the higher protein content of algae biomass. The hydrolysis of protein produces amino acids (containing a —NH₂ group) and carboxylic acids (containing a —COOH group), so deamination and decarboxylation are considered to be the main pathways for the decomposition of amino acids. The nitrogen compounds of biochar are not limited to high-protein biomasses such as algae. The dominant nitrogen form in algae is protein-N, which has a lower thermal stability.

A functionalized carbon derived from the hydrothermal liquefaction of an algal biomass is used to demonstrate the efficacy of this carbon in the adsorption of a series of chemical air pollutants (precursors of secondary organic aerosols in the atmosphere) emitted normally from bitumen at elevated temperatures. Using quantum-based computational modeling performed in the framework of density functional theory, the molecular interactions of six of bitumen's emitted chemicals with the targeted active sites of the algal biochar were calculated. The adsorbate molecules consist of O-containing compounds (benzoic acid, benzofuran, and hexanal) and S-containing compounds (dibenzothiophene, 3-pentylthiophene, and hexanethiol). In a comparative test, the average adsorption energy of each gas on the biochar surface is used to estimate the adsorption strength for each gas. Laboratory tests were performed using dynamic vapor sorption analysis under vacuum to measure the extent of adsorption of select gases by functionalized carbon.

Materials. Neat bitumen graded as PG 64-16 and supplied by HollyFrontier Corporation in Arizona (Table 12). The functionalized carbon was made from thermochemical conversion of algae (Cyanidioschyzon merolae). Adsorbents used for measurements were 2,3-benzofuran (99%, Sigma Aldrich), dibenzothiophene (analytical standard, Supelco) and benzoic acid (99.5%, Sigma Aldrich).

TABLE 12
Properties of PG 64-16 Bitumen

| | |
|---|---|
| Specific Gravity @15.6° C. | 1.025 |
| Flashpoint ° C. | 300 |
| Absolute Viscosity, P @60° C. | 2.005 |
| G*/sinδ, kPa @64° C. | 1.23 |
| Mass change after RTFO | −0.210% |
| G*/sinδ, kPa @64° C. | 3.33 |
| G*sinδ, kPa @28° C. | 2.87 |
| Stiffness (MPa) @ 60 s, @−6° C. | 90.4 |
| m-value @ 60 s, @−6° C. | 0.384 |

Dynamic Vapor Sorption Method. The adsorption/desorption properties of functionalized carbon were measured by an automated vacuum vapor/gas gravimetric sorption analyzer (DVS Vacuum) from Surface Measurement Systems Ltd. During the test, the weight of the sample was measured directly and continuously using the SMS UltraBalance with a resolution of 0.1 μg throughout the experiment. A set partial pressure of solvent was introduced under vacuum using a mass flow controller connected to a flask filled with solvent, whereby saturated vapor pressure of solvent at the desired temperature was generated. The pressure control inside the vacuum chamber was done via a closed-loop proportional integral derivative (PID) control between the butterfly valve, pressure transducers, and mass flow controllers. The sorption measurements were done in a mass equilibrium mode, in which the mass equilibrium criteria were set as a change in mass per minute (dmdt). The control software automatically calculates and checks the dmdt criteria against the set dmdt value. When the sample's mass reaches equilibrium at a certain partial pressure of sorbate molecules within the set dmdt tolerance, the control software makes the test proceed to the next partial-pressure step.

DFT-Based Computational Methodology. Designing the model of the biochar surface is the first step in tracking the molecular interactions between the biochar surface (adsorbent) and our target gaseous molecules (adsorbates). The term “surface of alga biochar” is used for the solid sorbent related to the alga. However, this sorbent could be a macromolecule rather than a surface of a crystal. A typical biochar is dependent on its initial precursor (biomass), so a molecular model of a typical biochar is commonly designed based on the biochar's empirical formula and FTIR results. In contrast to graphene with its apparent crystalline properties, it is not easy to detect aromatic clusters in biochars derived at high temperature. In this example, the XRD peaks at 26.426° and 43.019° (2θ) indicated the presence of graphite-like carbon in the algae biochar derived by hydrothermal liquefaction. In addition, at the temperature range (300-350° C.) used in the production of biochar, the presence of randomly oriented polyaromatic clusters is expected. This is supported by the findings that the char prepared at the temperature range of 280-350° C. contained small polyaromatic rings connected through polyphosphate bridges.

The characteristics of the functional groups surrounding the central aromatic zone of the biochar model molecule are determined based on the analytical and spectroscopic studies performed on target alga. The FTIR adsorption peaks indicate the presence of alcoholic OHs and other O-containing functional groups such as phenols, carboxyl, carbonyl, and ketene. The presence of N-containing compounds in the algal biochar is evidenced by the bands at 2100-2270 cm⁻¹ corresponding to diimides and azides, and at 1600-1670 cm⁻¹ corresponding to N—H stretching of cyclic amides.

The biochar model molecule contains four N-functional groups: amide, amine, pyrrole, and pyridine. Since the focus is on the interactions of specific parts of the biochar char surface, not the entire surface, the central aromatic zone of the biochar model molecule is designed just for connecting the four targeted zones. The four active zones containing N-functional groups are: amide zone, amine zone, pyrrole zone, and pyridine zone. To simulate the chemical environment near the targeted N-functional groups (amide, amine, pyrrole, and pyridine), a part of the aromatic zone coordinated to that N-functional group was considered as the targeted zone. Each biochar zone was optimized to its minimum energy before introducing the gas molecules for interaction.

All energy optimizations on the four biochar sections, the gas adsorbate molecules, and their corresponding adsorption complexes were performed via DMol³ module implemented in the Accelrys Materials Studio program package (version 6.0). The PBE (Perdew-Burke-Ernzerhof) formulation of generalized gradient approximation (GGA) was used as the functional for all calculations. Due to the large polarizability of the algal biochar surface, the long-range van der Waals interactions needed to be included in the calculations to accurately estimate the thermodynamic stability and strength of adsorbent-adsorbate interactions. Grimme's long-range dispersion correction (PBE-D) was used as implemented in the DMol³ module of the Accelrys Materials Studio program package. All-electron double numerical basis sets augmented by polarization functions (DNP) was defined for the optimization process. “Fine” grid was specified for the matrix numerical integrations. At this level of integration, the tolerances for energy, maximum force, and displacement convergence were 1.0×10⁻⁵ Hartree, 2.0×10⁻³ Hartree/Å, and 5.0×10⁻³ Å, respectively.

During the adsorption of gas molecules on each part of the biochar surface, the thermodynamic stability of the adsorption complex formed was expressed through the adsorption energy (E_{ads}). E_{ads} is the energy difference between the adsorption complex formed and its constituents when they are in their lowest energy state, as shown in Eq. 11.

E_{ads}=E_{complex}−(E_{gas molecule}+E_{biochar zone}) (11)

The impact of functionalized carbon made from algal biomass on the delay in aging of bituminous composites is believed to be due at least in part to a delayed loss of volatile and oxygenated compounds of bitumen in the form of emissions. Among those volatiles are benzofuran, dibenzothiophene, and benzoic acid. To evaluate the capability of functionalized carbon to retain these gases, a dynamic sorption method was employed, using the above three gases referred to as adsorbents. To prepare samples, functionalized carbon was preheated to 50° C. and held at this temperature under vacuum (<1×10⁵ Torr) for 300 minutes, to ensure that residual species were removed from the sample pores. Then the sample was slowly cooled under vacuum to the desired temperature for isotherm measurements, and the above-mentioned adsorbents were introduced for measurement. The adsorption/desorption kinetics for benzofuran as well as total adsorption uptake versus partial pressure were assessed. Measurement of other adsorbents followed the same procedure; the results for all three adsorbents are summarized in Table 13. It was found that functionalized carbon was able to retain the adsorbents; the adsorption of benzofuran was the highest among the three, followed by benzoic acid and dibenzothiophene. Regardless of the variation in the extent of adsorption, the fact that functionalized carbon could retain these volatile compounds that would otherwise be emitted from bitumen can explain part of the delayed progress of aging. The molecular modelling used to quantify the binding energy between the typical volatile compounds emitted from bitumen and the functionalized carbon is described below.

TABLE 13
Adsorption capacity of functionalized carbon for
benzofuran, dibenzothiophene, and benzoic acid

| | Benzofuran | Dibenzothiophene | Benzoic Acid |
|---|---|---|---|
| Sample | uptake (wt %) | uptake (wt %) | uptake (wt %) |
| FC | 2.443 | 6.618 | 0.519 |

DFT-based modeling results. The proper features of an ideal solid sorbent such as a biochar are not limited to a large surface area and a high free volume; appropriate interactions between the adsorbate molecules and the solid sorbent are also considered. Adsorption of the target organic compounds on the biochar is partly a thermodynamic process based on differences in the adsorption energies of different compounds. Therefore, energy-based data can clarify the adsorption strength for different adsorbate molecules, indicating the capability of the biochar to adsorb the gases before they are released to the atmosphere.

The results discussed below indicate how a quantum-based density functional approach can be used to predict the adsorption behavior of a selected group of gas molecules, normally emitted from the bitumen surface, on the N-rich surface of algal biochar. A group of six adsorbate molecules (three O-containing and three S-containing compounds) supposed to interact with four active zones of the biochar surface containing N-functionals of amide, amine, pyridine, and pyrrole were selected. The O-containing compounds are benzoic acid, benzofuran, and hexanal (an aldehyde molecule). The S-containing compounds are dibenzothiophene, 3-pentylthiophene, and hexanethiol. These compounds were selected based on the role of polar emissions including sulfur and oxygen elements as precursors of secondary organic aerosols. At temperatures relevant to the life cycle of bitumen materials, hydrocarbons constitute a large fraction of bitumen emissions. However, O-containing and 5-containing emissions, contributing 1-14% and 5-30% of the total emissions, respectively, constitute a greater fraction at high temperatures. Solar exposure is believed to result in a 700% increase in emission of S-compounds, a 400% increase in O-compounds, and a 300% increase in hydrocarbons.

The highly aromatic S-compounds in bitumen emissions include chemical structures representing benzothiophenes and dibenzothiophenes; the complex mixture of O-containing emissions includes chemical structures representing benzofurans and dibenzofurans, commonly found in complex petroleum-based mixtures.

A biochar surface generally includes many O-containing functional groups, including phenols, alcohols, ketones, lactones, and carboxylic acids. However, the active zones targeted here have N-containing functional groups, since the distinctive performance of the algae biochar compared to other biochars is attributed to the function of N-compounds in algae biochar. The area of each active zone is not limited to an individual N-functional group, but also contains a small portion of the biochar surface coordinated to the N-functional group, to simulate the chemical environment around the functional. This is of interest because the nature of substituents (e.g., electron-withdrawing or electron-donating characteristics) near the N-functional group may impact the eventual performance of the N-functional group and its subsequent interactions with gas molecules.

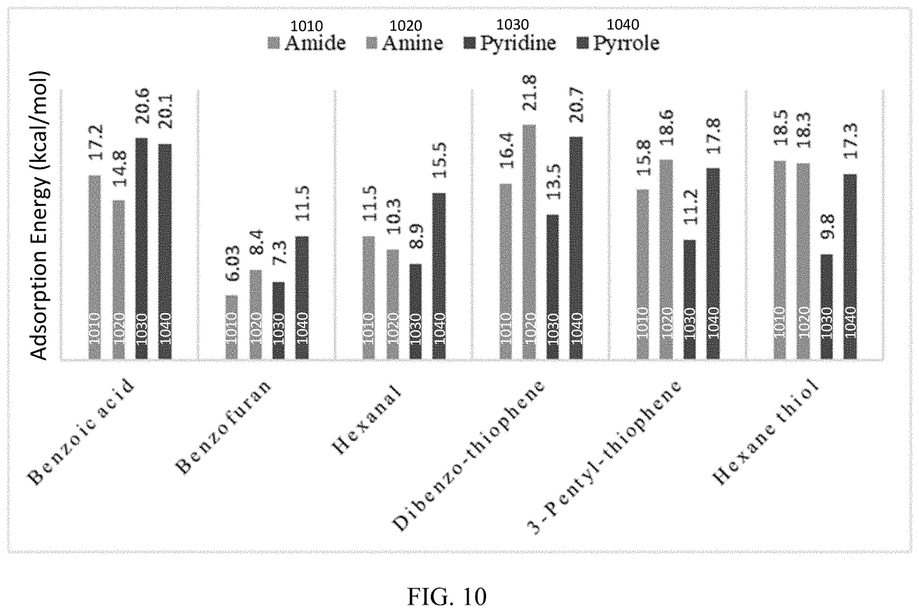

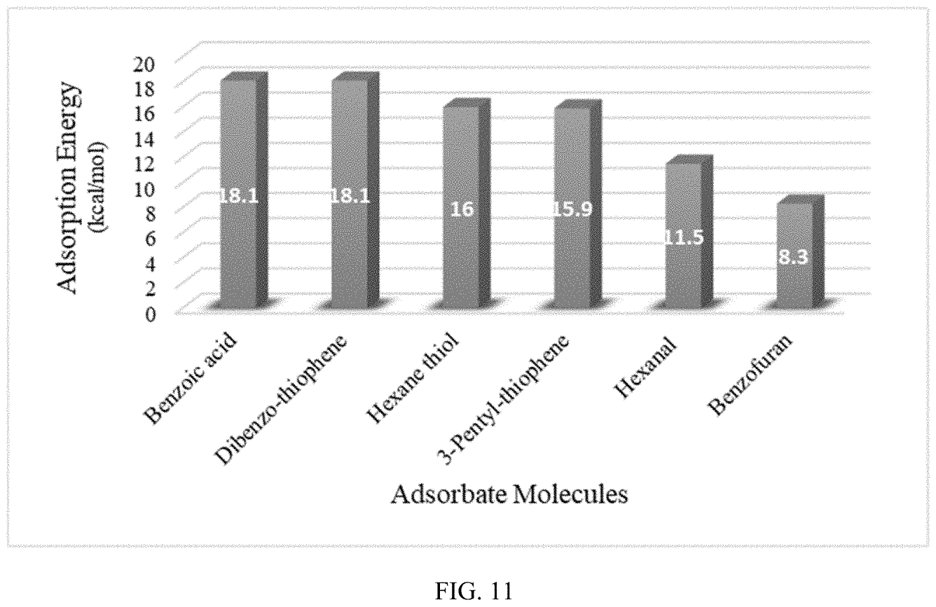

The results of interactions between the six gas molecules and the four active zones of biochar are shown in Table 14 and FIG. 10. Columns of FIG. 10 are related to the maximum adsorption energy of each gas on each active zone. The bars for each of benzoic acid, benzofuran, hexanal, dibenzothiophene, 3-pentylthiophene, and hexanethiol represent adsorption energy on amide 1010, amine 1020, pyridine 1030, and pyrrole 1040, from left to right. FIG. 10 shows the lowest adsorption energy for benzofuran compared to other gasses. To have a better evaluation of adsorption strength of each gas molecule, the average adsorption of each gas on four N-containing zones is plotted in FIG. 11. FIG. 11 confirms the low adsorption of benzofuran, with E=8.3 kcal/mol, and hexanal, with E=11.5 kcal/mol, compared to other gasses. Dibenzothiophene and benzofuran are two identified chemical compounds that are normally emitted from a bitumen surface. Based on DFT results, the distinction between their adsorptions (dibenzothiophene with average adsorption energy of 18.1 kcal/mol, and benzofuran with average adsorption energy of 8.3 kcal/mol) is so high that benzofuran is not believed to be well adsorbed by algae-based biochar. This discrepancy in adsorption strength implies that depending on the nature of interactions and thermodynamic stability of the newly formed complexes, the target biochar may selectively function as the sorbent for a specific group of organic compounds.

TABLE 14
The range of adsorption energy (kcal/mol) for interaction
of six chemical compounds, normally emitted from a
bitumen surface, with four active zones of an algal
biochar surface containing N-functional groups.

| Adsorbate | Amide | Amine | Pyridine | Pyrrole |
|---|---|---|---|---|
| Molecules | Zone | Zone | Zone | Zone |
| Benzoic acid | 16.9-17.2 | 8.6-14.8 | 13.0-20.6 | 14.8-20.1 |
| Benzofuran | 5.6-6.03 | 2.6-8.4 | 4.5-7.3 | 6.2-11.5 |
| Hexanal | 9.4-11.5 | 5.2-10.3 | 5.3-8.9 | 9.2-15.5 |
| Dibenzothiophene | 9.4-16.4 | 18.3-21.8 | 9.0-13.5 | 11.5-20.7 |
| 3-Pentylthiophene | 14.3-15.8 | 12.0-18.6 | 8.6-11.2 | 10.4-17.8 |
| Hexanethiol | 14.3-18.5 | 13.8-18.3 | 8.8-9.8 | 12.7-17.3 |

Interaction of benzoic acid and dibenzothiophene with N-components of the biochar surface. Benzoic acid is one the most common organic acids in the Earth's atmosphere and an important organic aerosol that reacts with OH, NO₃, and SO₄ radicals in the atmosphere. This simple aromatic acid is a weak acid (pKa=4.2) with irritating fumes at elevated temperatures. Benzoic acid is released to the environment in various ways, including biomass combustion and hot bitumen.

The adsorption reaction of benzoic acid by N-rich biochar was investigated by tracking the molecular interactions between this organic aerosol and four active zones containing N functional groups. Based on the energy results, the pyrrole zone (here, in the form of indole), and the pyridine zone (here, in the form of quinoline) have the best interaction with benzoic acid, evidenced by an E_{ads} of ˜20 kcal/mol, followed by the amide and amine zones at 17.2 and 14.8 kcal/mol, respectively.

Even for the interactions associated with the highest adsorption energies, no H-transfer or ionic interaction (e.g., between benzoic acid and the pyridine zone: C₆H₅—COO⁻ . . . ⁺HN—Ar) was observed between acid and N-containing zones. The maximum adsorption energies for benzoic acid and the pyrrole zone and pyridine zone concern H-bonding and other intermolecular forces, including dipole-dipole and dispersion.

Due to the chemical nature of benzoic acid and amine (as a base), two possible chemical reactions between two components were investigated: a simple ion pair reaction (C₆H₅—COO⁻ . . . ⁺H₃N—R); and an amidization reaction that occurs as the following reaction to produce R—NH—CO-Ar+H₂O,

Carboxylic acid+Amine→Amide+H₂O.

However, neither of these two reactions were performed successfully, indicating that the interactions between this weak acid and base are dominated by the physical interactions rather than the chemical reactions. In the amidization reaction, the energy released from this reaction (−7.8 kcal/mol) is less than the physical interactions between the two components (−8.6 to −14.8 kcal/mol).

Dibenzothiophene, a sulfur-containing polycyclic aromatic compound consisting of a thiophene ring flanked by two benzene rings, belongs to the intermediate-volatile organic compounds that have been recognized as contributors to secondary organic aerosols. As one of the most abundant O-containing compounds in the atmosphere (the others are anthraquinone, 9-fluorenone, and dibenzofuran), dibenzothiophene is emitted from burning wood, incomplete combustion, and non-combustion resources such as bitumen. Dibenzothiophene is also found in crude oil and petroleum, from which it is removed before further use.

Along with benzoic acid, dibenzothiophene shows the maximum adsorption on the biochar model surface, with average adsorption energy of −18.1 kcal/mol. The best performance of this polycyclic aromatic compound is related to its interactions with the amine zone (E_{ads}=−21.8 kcal/mol) and the pyrrole zone (E_{ads}=−20.7 kcal/mol). In either complex, the S atom of dibenzothiophene takes advantage of an H-bonding interaction with the NH part of the amine or pyrrole group that brings a thermodynamic stabilization for the newly formed adsorption complex. In addition, adsorption for dibenzothiophene is provided by its polyaromatic nature and the relatively high density that it carries due to its large size. The binding (relative) distance, defined based on the two centers of mass of the targeted compounds, is 4.2 Å, which is a common range for the binding distance of aromatic planes. In this case, two polyaromatic compounds are arranged in a displaced-parallel (offset) orientation, which is a favorable arrangement in which the π-electron repulsion of quadrupole/quadrupole interactions between two aromatic planes is minimized and the complex becomes stabilized.

Interaction of benzofuran with N-components of the biochar surface. Benzofuran and dibenzofuran are precursors to secondary organic aerosols; these precursors are often found in complex petroleum-based mixtures. Among the three O-containing gas molecules (benzoic acid, benzofuran, and hexanal), benzofuran has the least adsorption on the model surface of algae biochar. The best performance of benzofuran is its adsorption on the pyrrole zone (a substituted indole) with a stabilization energy of −11.5 kcal/mol. Its next best is its adsorption on the amine zone with a stabilization energy of −8.4 kcal/mol. Comparison of the adsorption complexes of dibenzothiophene-pyrrole zone with the benzofuran-pyrrole zone shows that while both structures benefit from a displaced-parallel arrangement with an H-bonding interaction, the former complex is stabilized much better than the latter complex, E_{ads}=−20.7 kcal/mol compared to E_{ads}=−11.5 kcal/mol. This energy difference highlights the importance of the number of aromatic rings in a polyaromatic compound (with the consequent electron density carried by those rings) on its π-π electron interactions.

Also, comparison of the arrangements and stabilization energies for the two adsorption complexes benzoic acid-pyrrole zone and benzofuran-pyrrole zone, further supports this explanation that the most effective non-bonding interactions in the benzoic acid complex compared to the benzofuran complex provide a higher stability for the former complex (E_{ads}=−20.1 kcal/mol) compared to the latter one (E_{ads}=−11.5 kcal/mol). Therefore, despite the smaller electron density of benzoic acid, due to its smaller size compared to benzofuran, the functional groups of benzoic acid perform better than those of benzofuran in adsorption on the surface of algal biochar.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A composite comprising:
a polymeric material or emulsion; and
biochar, wherein the composite comprises 1 wt % to 20 wt % of the biochar.

2. The composite of claim 1, wherein the biochar comprises biochar from algae, food waste, animal waste, cellulose-containing material, or a combination thereof.

3. The composite of claim 2, wherein the cellulose-containing material comprises palm sheath.

4. The composite of claim 1, wherein the biochar is functionalized with nitrogen-containing groups or compounds, oxygen-containing groups or compounds, or both.

5. A building material comprising the composite of claim 1.

6. A method of making a composite, the method comprising:
combining biochar with a polymeric material or emulsion to yield a modified polymeric material or emulsion; and
homogenizing the modified polymeric material or emulsion to yield the composite.

7. The method of claim 6, wherein the biochar is a by-product of biofuel production, liquefaction, pyrolysis, or a combination thereof.

8. The method of claim 7, where the liquefaction comprises thermochemical liquefaction or hydrothermal liquefaction.

9. The method of claim 6, wherein the composite comprises 1 wt % to 20 wt % of the biochar.

10. The method of claim 6, wherein the biochar comprises biochar from algae, food waste, animal waste, cellulose-containing material, or a combination thereof.

11. A method of functionalizing biochar, the method comprising:
removing contaminants from the biochar to yield decontaminated biochar;
oxidizing the decontaminated biochar to yield oxidized biochar; and
functionalizing the oxidized biochar.

12. The method of claim 11, wherein removing contaminants from the biochar comprises sonicating the biochar to yield purified graphene oxides.

13. The method of claim 12, further comprising exfoliating graphene sheets from the purified graphene oxides.

14. The method of claim 11, wherein oxidizing the biochar comprises contacting the biochar with an acid.

15. The method of claim 11, wherein functionalizing the biochar comprises contacting the oxidized biochar with a solution comprising a source of functional groups.

16. The method of claim 15, further comprising coupling the functional groups to the oxidized biochar.

17. The method of claim 15, wherein the source of functional groups comprises a source of amine groups or a source of phosphorus.

18. The method of claim 17, wherein the source of amine groups comprises urea.

19. A method of making nitrogen-doped biochar, the method comprising:
combining urea and wood residue to form a mixture; and
heating the mixture in an oxygen-free environment to form the nitrogen-doped biochar.

20. The method of claim 19, wherein a weight ratio of the urea to the wood residue is in a range of about 0.1:1 to about 10:1.
